(19) United States
(12) Patent Application Publication
(10) Pub. No.: US 2006/0037631 A1
(43) Pub. Date: Feb. 23, 2006

(54) Warewash machine and related door construction

(76) Inventor: Steven H. Kramer, Osgood, OH (US)

Correspondence Address: THOMPSON HINE LLP, 2000 COURTHOUSE PLAZA N.E., 10 WEST SECOND STREET, DAYTON, OH, 45402-1758, US

(21) Appl. No.: 10/922,452

(22) Filed: Aug. 20, 2004

(51) Int. Cl. B08B 3/00; B08B 3/12

(52) U.S. Cl. 134/56 D; 134/58 D; 134/200

(57) ABSTRACT

A warewash machine includes a frame in part defining a wash area having at least one access opening, a lower housing at least in part defining a lower side of the access opening and an upper housing at least in part defining a top side of the access opening. The upper housing has an upper surface and a side surface extending downward therefrom with the side surface having a substantially fixed position with respect to the upper surface. The upper housing also includes an internal, upwardly extending arm receiving chamber located above the washing area. Disposed in the chamber is an arm that is configured to direct fluid into the wash area. A door panel is mounted for movement between a closed position for washing and an open position for inlet and outlet of wares. When the door panel is in the closed position, it closes the access opening and a top edge of the door panel is located proximate to a lower edge of the side surface of the upper housing. When the door panel is in the raised position, the top edge of the door panel is located above the upper surface of the upper housing and the lower edge of the door panel is located proximate the lower edge of the side surface of the upper housing.

### TECHNICAL FIELD

The present application relates to machines for washing wares.

### BACKGROUND

Warewash machines have become fairly standardized in the industry. Typically, a standard warewasher has a washing chamber with an access opening that allows wares to be placed within the chamber for a washing operation. While larger washing chambers have become desirable, especially taller chambers, it is necessary that the warewash machines having larger washing chambers be dimensioned to fit within a volume that can be accommodated by, e.g., a dish room of a restaurant, especially those dish rooms with limited ceiling heights. To this end, a collapsible, vertically opening, telescoping door has been proposed. The telescoping door includes multiple panels that can slide relative to each other as the door is moved to the open position.

### SUMMARY

In an aspect, a warewash machine includes a frame in part defining a wash area having at least one access opening, a lower housing at least in part defining a lower side of the access opening and an upper housing at least in part defining a top side of the access opening. The upper housing has an upper surface and a side surface extending downward therefrom with the side surface having a substantially fixed position with respect to the upper surface. The upper housing also includes an internal, upwardly extending arm receiving chamber located above the washing area. Disposed in the chamber is an arm that is configured to direct fluid into the wash area. A door panel is mounted for movement between a closed position for washing and an open position for inlet and outlet of wares. When the door panel is in the closed position, it closes the access opening and a top edge of the door panel is located proximate to a lower edge of the side surface of the upper housing. When the door panel is in the raised position, the top edge of the door panel is located above the upper surface of the upper housing and the lower edge of the door panel is located proximate the lower edge of the side surface of the upper housing.

In another aspect, a warewash machine includes a frame in part defining a multi sided wash area. A cap-shaped housing is atop the wash area and has a top wall portion and downwardly extending and stationary first, second and third sidewall portions to in part define a recessed space extending upward from the wash area and open to the wash area. Positioned within the recessed space is at least one liquid distribution arm for delivering liquid down to the wash area. A wrap-around hood unit that includes first, second and third wall portions is mounted on the frame for movement upward and downward between a closed position for enclosing the wash area for washing and a fully open position for providing access to the wash area for inlet and outlet of wares from the wash area. When the wrap-around hood unit is in the closed position, a top edge of each of the first, second and third wall portions is positioned proximate to a lower edge of a corresponding one of the first, second and third sidewall portions of the cap-shaped housing so that the top edge of each of the first, second and third wall portions is spaced apart from and lower than the top wall portion of the cap-shaped housing. When the wrap-around hood unit is in the fully open position, a lower edge of each of the first, second and third wall portions is positioned proximate to a lower edge of the corresponding one of the first, second and third sidewall portions of the cap-shaped housing.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a perspective view of an embodiment of a warewash machine.

FIG. 1A is a detail view at area A of FIG. 1.

FIG. 2 is a perspective view of an embodiment of a door for use with the warewash machine of FIG. 1.

FIGS. 3 and 4 are front and section views, respectively, of the warewash machine of FIG. 1 with the door of FIG. 2 in the closed position.

FIGS. 4A and 4B are detail views at areas A and B, respectively, of FIG. 4.

FIGS. 5 and 6 are front and detail views, respectively, of the warewash machine of FIG. 1 with the door of FIG. 2 in the open position.

FIG. 6A is a detail view at area A of FIG. 6.

FIGS. 7 and 8 are side views of the warewash machine of FIG. 3 with the door in closed and open positions, respectively.

### DETAILED DESCRIPTION

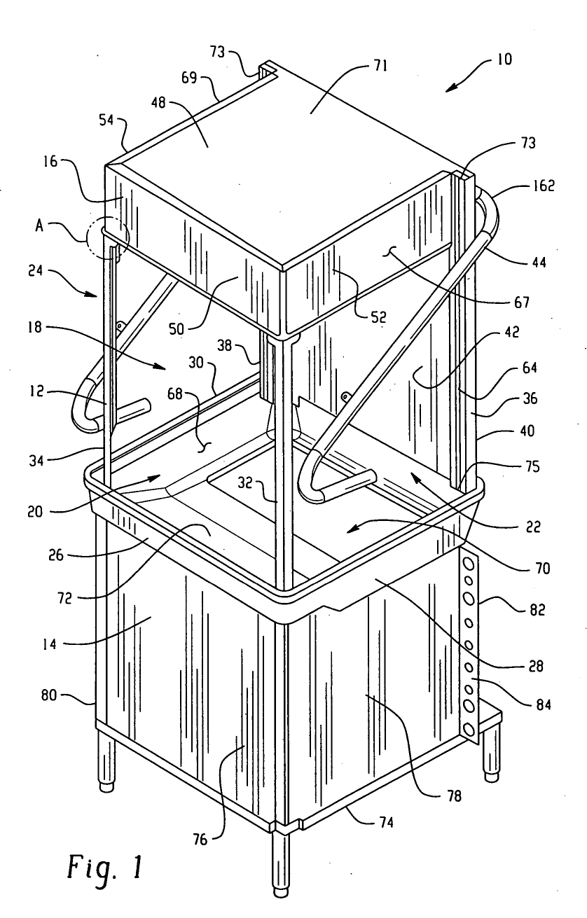

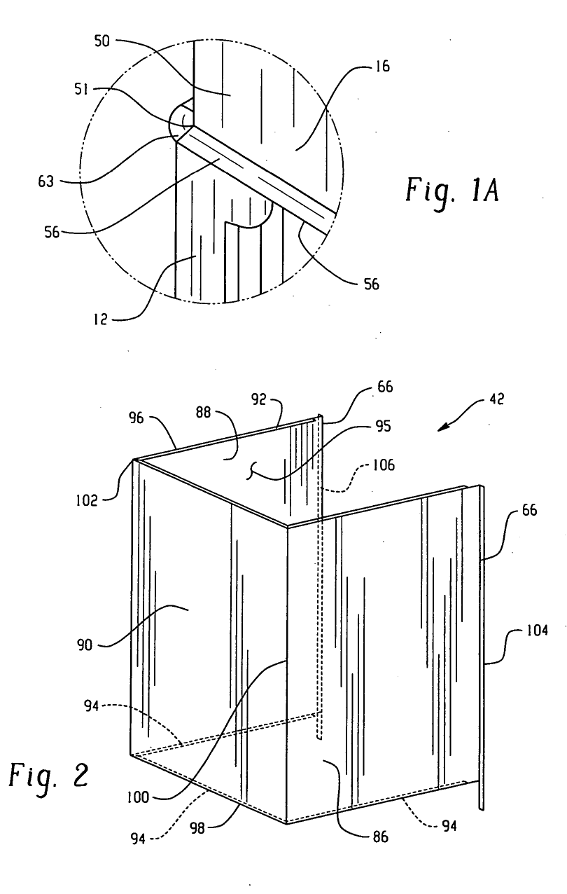

Referring to FIG. 1, a warewash machine 10 includes a frame 12, a lower housing 14, an upper housing 16 spaced from the lower housing and a washing chamber 18 located between the upper and lower housings. For the placement and removal of wares into and out of the washing chamber 18, a set of access openings 20, 22, 24 are provided. The access openings 20, 22, 24 are disposed at the front 26 and sides 28, 30, respectively, of the warewash machine 10 and are each formed between the upper and lower housings 14, 16 and associated frame members 32, 34, 36, 38. At a rear side 40 of the warewash machine 10, a rear panel 42 is fixedly attached to the warewash machine, e.g., to inhibit access to the washing chamber 18 from the rear side 40. To control access to the washing chamber 18 from the front 26 and sides 28, 30, a three-sided door 42 (FIG. 2) is provided that can slide between closed and open positions using arm 44, as will be described in greater detail below.

The upper housing 16 includes a top, horizontal panel 48 and multiple side panels 50, 52 and 54 extending downwardly from the top panel 48. Side panels 50, 52, 54 are fixedly attached to frame 12 and the orientation of each side panel 50, 52 and 54 is substantially fixed relative to the top panel 48 irrespective of whether the door 42 is in the open or closed positions. Referring also to FIG. 1A, extending horizontally from the side panels 50, 52 and 54 are associated lips 56. The lips 56 are each located near a bottom edge 62 of the associated side panel. As can most clearly be seen in FIG. 1A, the lips 56 of the upper housing 16 are spaced from each other at corners 51 of the upper housing 16 with end surface 63 of the associated frame member 32, 36, 36 spanning a gap between the lips. The lips can be interconnected, e.g., forming a single, continuous lip extending about the periphery of the upper housing 16. In some embodiments, the upper housing is an assembly of multiple, discrete panels that are, for example, adhered, welded and/or fastened together. In other cases, the upper housing is formed as a single, unitary piece with the side panels extending from the top panel. The rear panel 42 forms a rear wall of the upper housing 16.

Referring back to FIG. 1, supporting the upper housing 16 is frame 12. Frame 12 includes four frame members 32, 34, 36 and 38 that are oriented to form parallelepiped-shaped washing chamber 18 between the frame members and the upper and lower housings 16 and 14. It is contemplated that in some embodiments one or more of the frame members might be eliminated. Frame members 36 and 38 also include an associated track 64 that runs along the long axis of the frame member. The tracks 64 are sized to receive an edge 66 of the door 42 to allow the door to slide along the track between open and closed positions. As can be seen, frame members 36 and 38 are longer than frame members 32 and 34 and extend alongside outer surfaces 67 and 69 of the upper housing 16 to top surface 71. Tracks 64 extend along the entire length of the frame members 36 and 38 and are open at each end 73 and 75 of the associated frame member.

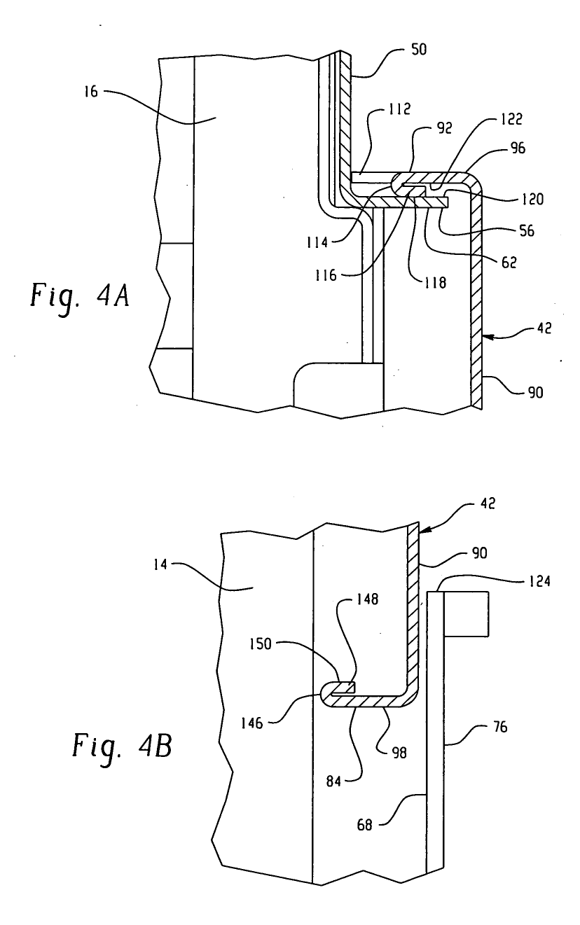

The frame members 32, 34, 36 and 38 are mounted to inner side surfaces 68 of lower housing 14. The lower housing 14 supports the frame members and the upper housing 16 in a vertical orientation with the upper housing 16 located above the washing chamber 18. The lower housing 14 includes a water tank 70 extending into the lower housing from an upper rinse surface 72, a bottom wall 74 and sidewalls 76, 78, 80 and 82 extending between the upper rinse surface and the bottom wall. A drain 77 (FIG. 4) is located in the lower housing 14 and is in communication with the water tank 70 to allow drainage from the washing chamber 18 to pass from the warewash machine 10 through the drain 77. Extending from sidewall 78 is mounting structure 84 (e.g., for mounting a pump assembly, which is not shown).

Referring now to FIG. 2, door 42 includes side panels 86 and 88 and a transverse front panel 90 extending between the side panels to form a three-piece hood configuration. Panels 86, 88 and 90 are dimensioned to completely span access openings 20, 22 and 24, respectively, and about three sides of the parallelepiped-shaped washing chamber 18 when the door 42 is in the closed position. Extending along an inner surface 95 of each of the panels 86, 88 and 90 are a pair of associated door lips 92, 94 with lips 92 located at an upper edge 96 of the door 42 and lips 94 located at a lower edge 98 of the door. Each of the upper lips 92 and the lower lips 94 are separated from adjacent lip(s) at corners 100, 102. However, other configurations are possible, such as a single, continuous upper and/or lower lip extending along each of the panels 86, 88, 90.

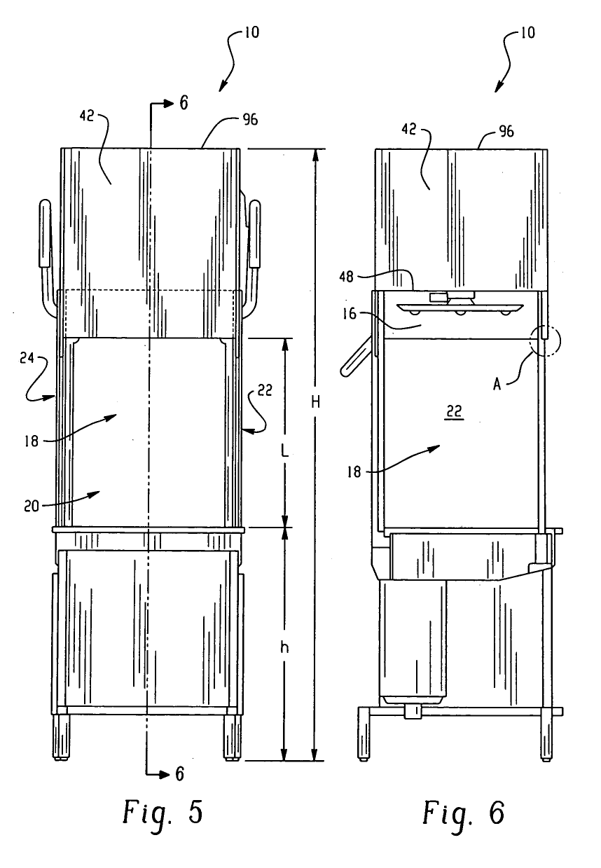

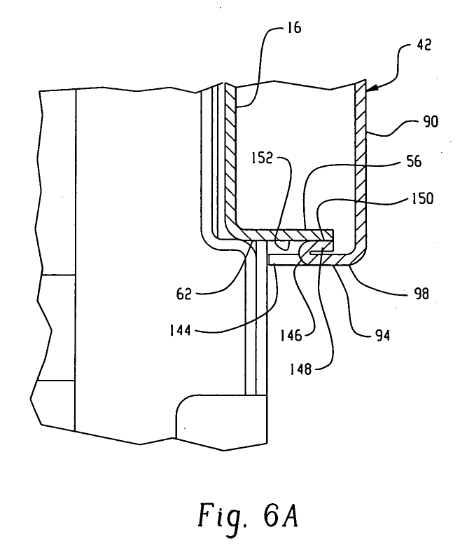

Vertical rails 104, 106 are located at rear edges 66 of the door 42. The rails 104 and 106 are sized to ride within track 64 with rail 104 sized to ride along the track associated with frame member 36 and rail 106 sized to ride along the track associated with rail member 38. Rails 104, 106 are of greater length than panels 86 and 88 to allow lip 94 of the door 42 to contact lip 56 of the upper housing 16 when the door is in the open position as will be described below with reference to FIGS. 5-6A.

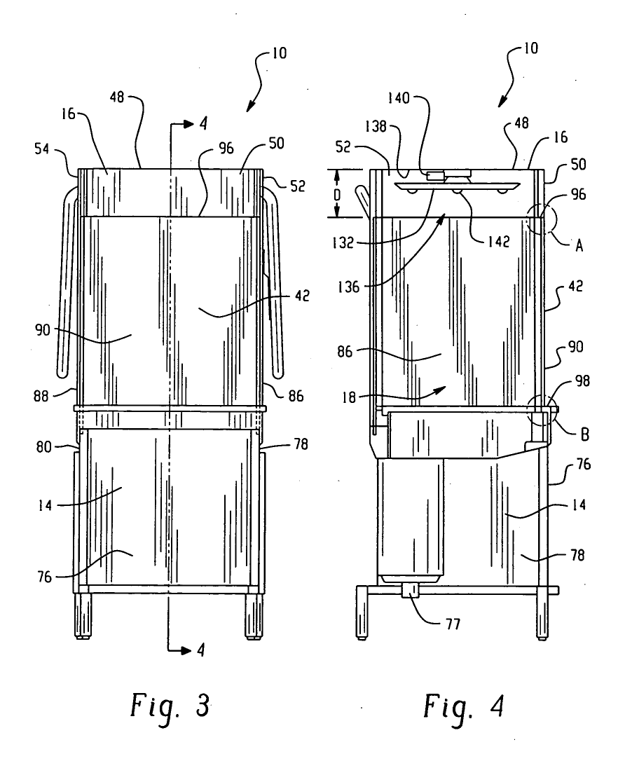

Referring now to FIGS. 3 and 4, warewash machine 10 is shown with door 42 in the closed position. In this position, the door 42 is disposed between the upper housing 16 and the lower housing 14, with panels 50, 52, 54 of the upper housing 16 being exposed above upper edge 96 of the door and panels 76, 78, 80 of the lower housing 14 being exposed below lower edge 98 (FIG. 4) of the door.

Referring to FIG. 4A, lip 56 of the upper housing 16 and lip 92 of the door 42 cooperate to position the door in the closed position. Located at a free end 112 of lip 92 is a fold 114 having a folded-over portion 116 that is folded back toward respective panels 50, 52 and 54. In the closed position, a bottom surface 118 of the folded over portion 116 of the fold 114 abuts an upper surface 120 of lip 56 of the upper housing 16. Alternatively, lip 92 may not include a fold. Other configurations are also contemplated. For example, lip 92 may include a stop (not shown) such as a rubber stop or fluid-tight seal that is affixed to lower surface 122.

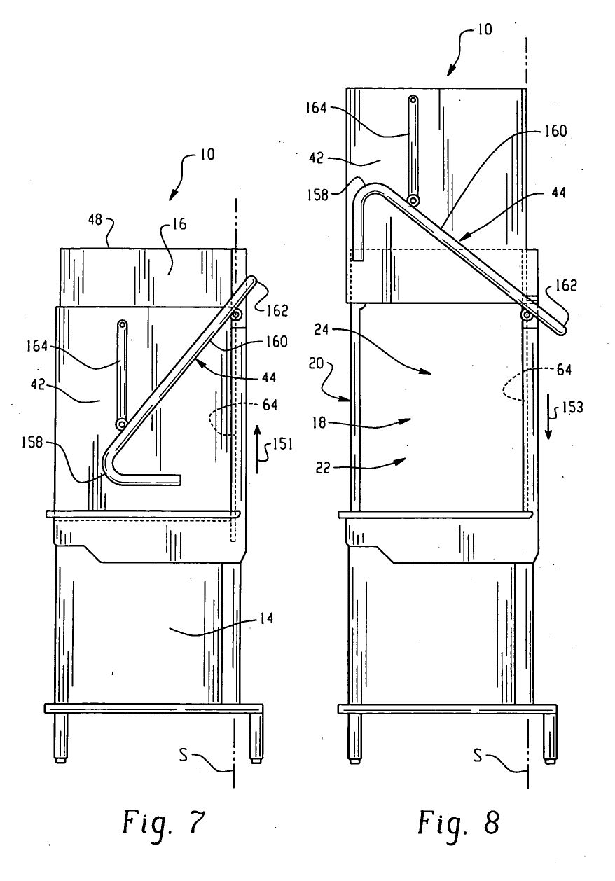

Referring still to FIG. 4A, top edge 96 of each panel 86, 88, 90 of the door 42 is located proximate of the bottom edge 62 and below top panel 48 (FIG. 4) of the upper housing 16 when the door is in the illustrated closed position. In some embodiments, with the door in the closed position, top edge 96 is located no more than one inch (e.g., no more than 0.5 inch) from bottom edge 62 measured along a line parallel to the sliding axis S (FIGS. 7 and 8) of the door.

Referring to FIG. 4B, with the door still in the closed position, lower edge 98 of each panel 86, 88, 90 of the door 42 is located internal of and suspended below an upper edge 124 of the lower housing 14. In some embodiments, lower edge 98 is located no more than four inches (e.g., no more than two inches, no more than one inch) from the upper edge 124 measured along a line parallel to the sliding axis S. The lower edges 98 are suspended due to the contact between the lips 92 and 56 of the door 42 and upper housing 16, respectively.

Referring back to FIG. 4, a wash arm 132 is located within a chamber 136 formed by upper housing 16. The wash arm 132 is affixed at a lower surface 138 of top panel 48 and includes a fluid inlet 140 capable of fluid communication with a water source and multiple fluid outlets 142 capable of fluid communication with inlet 140. During a washing operation, liquid (e.g., water) can be directed downward through the outlet 142 of the wash arm 132 and into the washing chamber 18. In some embodiments, the depth D of the chamber 136 is at least about four inches (e.g., between about four inches and about eight inches, such as about seven inches).

Referring to FIGS. 5 and 6, the door 42 of the warewash machine is shown in an open position. In this position, a user can access the washing chamber 18 through any one of access openings 20, 22 and 24.

Referring to FIG. 6A, lip 56 of the upper housing 16 and lip 94 of the door 42 cooperate to limit upward movement of the door as it is moved to the open position. Located at a free end 144 of lip 94 is a fold 146 having a folded over portion 148 that is folded back toward respective panels 86, 88 and 90. In the open position, an upper surface 150 of the folded over portion 148 of the fold 146 abuts a lower surface 152 of lip 56 of the upper housing 16. Alternatively, lip 94 may not include a fold. Other configurations are also contemplated. For example, lip 94 may include a stop (not shown) such as a rubber stop that is affixed to upper surface 154.

Referring still to FIG. 6A, in the door open position, bottom edge 98 of each of the panels 86, 88, 90 of the door 42 is located proximate of the bottom edge 62 of the upper housing 16. In some embodiments, with the door in the open position, bottom edge 98 is located no more than one inch (e.g., no more than 0.5 inch) from bottom edge 62 measured along a line parallel to the sliding axis S (FIGS. 7 and 8) of the door.

Referring back to FIGS. 5 and 6, with the door 42 in the open, raised position, upper edge 96 of each panel 86, 88, 90 of the door 42 is located above top panel 48 of the upper housing 16 (FIG. 5). In some embodiments, H is at most about 90.5 inches, e.g., between about 88.5 and about 90.5 inches, such as about 90 inches. With the door 42 in the fully open position, the height L of each access opening is between about 26 and 28 inches, such as about 27 inches. The height h, from the bottom of the unit to the lower edge of the access openings, may be at least about 30 inches, in some cases up to about 34 inches.

Referring now to FIGS. 7 and 8, the door 42 can be slidably moved between the closed and open positions (FIGS. 7 and 8, respectively) using pivoting handle 44. The handle 44 is mounted on the warewash machine and includes a pair of arcuate sections 158 (one shown), a pair of straight sections 160 (one shown) and a transverse section 162 (see FIG. 1). The handle 44 is pivotally mounted on the warewash machine and is coupled to the door 42 by a pair of flat link bars 164 (one shown).

To open the door 42, an operator lifts upwardly on the handle 44 mounted on the outside of the door 42 to cause the door 42 to slide upwardly in the tracks 64 along axis S in the direction of arrow 151. Referring to FIG. 8 and also to FIG. 6A, the door 42 can be lifted until the lip 94 contacts the lower surface 152 of the lip 56 of the upper housing 16. In this position, the washing area 18 can be accessed through the exposed access openings 20, 22, 24.

To close the door 42, downward force is applied to the handle 44; or, in some cases, upward force is removed from the handle to allow the door to move toward the lower housing 14 along axis S in the direction of arrow 153. The door 42 can move downward until lip 92 contacts upper surface 120 of lip 56.

A number of detailed embodiments have been described. Nevertheless, it will be understood that various modifications may be made. For example, as an alternative to the three-piece wrap around hood configuration described above, the door may include only a single panel that is slidable between open and closed positions as described above, or the warewash machine may include multiple, separate panels that are independently slidable between open and closed positions as described above. Accordingly, other embodiments are within the scope of the following claims.

What is claimed is:

1. A warewash machine comprising:
a frame in part defining a wash area having at least one access opening;
a lower housing at least in part defining a lower side of the access opening;
an upper housing at least in part defining a top side of the access opening, the upper housing having an upper surface and a side surface extending downward therefrom, the side surface having a substantially fixed position with respect to the upper surface, the upper housing including an internal upwardly extending arm receiving chamber located above the washing area;
an arm disposed within the chamber, the arm configured to direct fluid into the wash area; and
a door panel mounted for movement between a closed position for washing and an open position for inlet and outlet of wares, when the door panel is in the closed position it closes the access opening and a top edge of the door panel is located proximate to a lower edge of the side surface of the upper housing, when the door panel is in the raised position, the top edge of the door panel is located above the upper surface of the upper housing and the lower edge of the door panel is located proximate the lower edge of the side surface of the upper housing.

2. The warewash machine of claim 1, wherein the side surface of the upper housing includes an outwardly extending lip at its lower edge, the door panel including an inwardly extending lip at its top edge, when the door panel is in the closed position the inwardly extending lip of the door panel rests upon the outwardly extending lip of the side surface of the upper housing to limit downward movement of the door panel.

3. The warewash machine of claim 2, wherein the inwardly extending lip of the door panel includes a fold having a folded-over portion, when the door panel is in the closed position the folded-over portion rests upon the outwardly extending lip of the side surface of the upper housing.

4. The warewash machine of claim 2, wherein, when the door panel is in the closed position, the lower edge of the door panel is positioned to an internal side of the lower housing, with the lower edge of the door panel positioned lower than a top edge of the lower housing.

5. The warewash machine of claim 4, wherein the lower edge of the door panel is in a suspended, non-supported position when the door panel is in the closed position.

6. The warewash machine of claim 1, wherein an overall height of the warewash machine when the door panel is in the fully open position is between about 88.5 and 90.5 inches.

7. The warewash machine of claim 6, wherein the overall height of the warewash machine when the door panel is in the fully open position is about 90 inches.

8. The warewash machine of claim 6, wherein a vertical height of the access opening is between about 26 inches and about 28 inches.

9. The warewash machine of claim 8, wherein the vertical height of the access opening is about 27 inches.

10. The warewash machine of claim 1, wherein the frame includes a track configured to receive the door panel and to allow movement of the door panel along a substantially vertical axis.

11. The warewash machine of claim 1, wherein the side surface of the upper housing includes an outwardly extending lip at its lower edge, the door panel including an inwardly extending lip at its lower edge, when the door panel is in the open position the inwardly extending lip of the door panel rests adjacent the outwardly extending lip of the side surface of the upper housing to limit upward movement of the door panel.

12. The warewash machine of claim 11, wherein the inwardly extending lip of the door panel includes a fold having a folded-over portion, when the door panel is in the open position the folded-over portion rests adjacent the outwardly extending lip of the side surface of the upper housing.

13. A warewash machine comprising:
a frame in part defining a multi sided wash area;
a cap-shaped housing atop the wash area having a top wall portion and downwardly extending and stationary first, second and third sidewall portions to in part define a recessed space extending upward from the wash area and open to the wash area;
at least one liquid distribution arm positioned within the recessed space for delivering liquid down to the wash area;
a wrap-around hood unit including first, second and third wall portions, the wrap around hood unit mounted on the frame for movement upward and downward between a closed position for enclosing the wash area for washing and a fully open position for providing access to the wash area for inlet and outlet of wares from the wash area, when the wrap-around hood unit is in the closed position a top edge of each of the first, second and third wall portions is positioned proximate to a lower edge of a corresponding one of the first, second and third sidewall portions of the cap-shaped housing so that the top edge of each of the first, second and third wall portions is spaced apart from and lower than the top wall portion of the cap-shaped housing, and when the wrap-around hood unit is in the fully open position a lower edge of each of the first, second and third wall portions is positioned proximate to a lower edge of the corresponding one of the first, second and third sidewall portions of the cap-shaped housing.

14. The warewash machine of claim 13, wherein each of the first, second and third sidewall portions of the cap-shaped housing includes an outwardly extending lip at its lower edge, each of the first, second and third wall portions of the wrap-around hood unit includes an inwardly extending lip at its top edge, when the wrap-around hood unit is in the closed position the inwardly extending lip of each of the first, second and third wall portions of the wrap-around hood unit rests upon the outwardly extending lip of the corresponding one of the first, second and third sidewall portions of the cap-shaped housing to limit downward movement of the wrap-around hood unit.

15. The warewash machine of claim 14, wherein at least one inwardly extending lip of the wrap-around hood includes a fold having a folded-over portion, when the wrap-around hood unit is in the closed position the folded-over portion rests upon the respective outwardly extending lip of the cap-shaped housing.

16. The warewash machine of claim 14 further comprising:
first, second and third lower wall portions spaced apart from and below the first, second and third sidewall portions of the cap-shaped housing, when the wrap-around hood unit is in the closed position the lower edge of each of the first, second and third wall portions of the wrap-around hood unit is positioned to an internal side of a corresponding one of the first, second and third lower wall portions, with the lower edge of each of the first, second and third wall portions of the wrap-around hood unit positioned lower than a top edge of the corresponding one of the first, second and third lower wall portions.

17. The warewash machine of claim 16, wherein the lower edge of each of the first, second and third wall portions of the wrap-around hood unit is in a suspended, non-supported position when the wrap-around hood unit is in the closed position.

18. The warewash machine of claim 14, wherein the first sidewall and second sidewall of the cap-shaped housing meet at one corner of the cap-shaped housing, and a corner lip portion extends from the lip of the first sidewall to the lip of the second sidewall, and wherein the second sidewall and the third sidewall of the cap-shaped housing meet at another corner of the cap-shaped housing, and a corner lip portion extends from the lip of the second sidewall to the lip of the third sidewall.

19. The warewash machine of claim 13, wherein an overall height of the warewash machine when the wrap-around hood unit is in the fully open position is between about 88.5 and 90.5 inches.

20. The warewash machine of claim 19, wherein the overall height of the warewash machine when the wrap-hood unit is in the fully open position is about 90 inches.

21. The warewash machine of claim 19, wherein the frame in part defines first, second and third openings to the wash area, and a height of each opening is between about 26 inches and about 28 inches.

22. The warewash machine of claim 21, wherein the height of each opening is about 27 inches.

23. The warewash machine of claim 13, wherein the frame includes a track configured to receive the wrap-around hood unit and to allow movement of the wrap-around hood unit relative to the frame along a substantially vertical axis.

24. The warewash machine of claim 13, wherein each of the first, second and third sidewall portions of the cap-shaped housing includes an outwardly extending lip at its lower edge, each of the first, second and third wall portions of the wrap-around hood unit includes an inwardly extending lip at its bottom edge, when the wrap-around hood unit is in the open position the inwardly extending lip of each of the first, second and third wall portions of the wrap-around hood unit rests adjacent the outwardly extending lip of the corresponding one of the first, second and third sidewall portions of the cap-shaped housing to limit upward movement of the wrap-around hood unit.

25. The warewash machine of claim 24, wherein at least one inwardly extending lip of the wrap-around hood includes a fold having a folded-over portion, when the wrap-around hood unit is in the open position the folded-over portion rests adjacent the respective outwardly extending lip of the cap-shaped housing.
